(19) United States
(12) Patent Application Publication
(10) Pub. No.: US 2020/0222860 A1
(43) Pub. Date: Jul. 16, 2020

(54) METHOD FOR PREPARING MEMBRANE SELECTIVE LAYERS BY INTERFACIAL FREE RADICAL POLYMERIZATION

(71) Applicant: Trustees of Tufts College, Medford, MA (US)

(72) Inventors: Ilin Sadeghi, Medford, MA (US); Ayse Asatekin Alexiou, Arlington, MA (US); Hyunmin Yi, Lexington, MA (US)

(21) Appl. No.: 16/631,338

(22) PCT Filed: Jul. 26, 2018
(86) PCT No.: PCT/US18/43844

§ 371 Date: Jan. 15, 2020

Related U.S. Application Data
(60) Provisional application No. 62/538,297, filed on Jul. 28, 2017.

(51) Int. Cl. B01D 69/12; B01D 67/00; B01D 69/08; B01D 71/44; B01D 69/02; B01D 71/52; B01D 71/76

(52) U.S. Cl. CPC B01D 69/125; B01D 67/0006; B01D 69/08; B01D 71/44; B01D 69/02; B01D 2325/34; B01D 71/76; B01D 2323/18; B01D 2323/22; B01D 2325/04; B01D 71/52

(57) ABSTRACT

A method for coating a porous support with a thin membrane selective layer via interfacial free-radical polymerization. The method is carried out by immersing a porous support in a monomer-containing solution, removing the porous support from the solution, covering the porous support with a second solution immiscible with the first solution, the second solution containing a polymerization initiator, activating the initiator to effect polymerization of the monomer, and washing the porous support having the membrane selective layer. Also disclosed are membranes prepared by the method and filtration methods using the membranes.

### GOVERNMENT SUPPORT

This invention was made with government support under Grant Nos. CBET-1553661 and CBET-1703549 awarded by the National Science Foundation. The government has certain rights in the invention.

### BACKGROUND

Membrane technology is crucial for many separation processes including to water treatment, bioseparations, and food and beverage processing.¹⁻³ Despite the diversity in applications, membranes are made through only a handful of polymer chemistries. This is largely driven by the success of manufacturing methods in creating the desired morphology.²⁻³ This is especially true for thin film composite (TFC) membranes, which have an ultra-thin, dense selective layer that controls selectivity, supported by a porous layer that imparts mechanical integrity.

Most current TFC membranes include cross-linked polyamide selective layers made via interfacial polymerization (IP).⁴⁻⁵ The existing IP method provides a very thin selective layer using a simple, scalable roll-to-roll process, resulting in high flux. Yet, this manufacturing method is limited to a narrow range of polymer chemistries.

Many polymers synthesized by other methods are difficult to form into sufficiently thin and defect-free selective layers during coating.⁶⁻⁷ For example, polymer layers can be grafted from the support membrane surface, but this often requires use of high-energy processes, e.g., irradiation and plasma, to generate initiating sites and long reaction time to produce a complete, defect-free selective layer.^{6,8}

Hydrogels are widely studied as membrane selective layers as they hold promise as effective, versatile, tunable, functionalizable, and inherently fouling resistant selective layers.⁶ Their effective pore size is controlled by the mesh size of the cross-linked polymer, typically in the ultrafiltration (UF) range (1-5 nm).¹³ Selectivity can be modulated by the addition of functional groups such as charged units that impart charge-based selectivity via Donnan exclusion. Hydrogels are especially suitable for the incorporation of nanomaterials that add new functionalities. Responsive properties can be imparted by proper selection of monomers. Hydrogel coatings are also used to prevent fouling.¹⁴ In each case, however, the addition of a hydrogel layer decreases permeance. The thicker the hydrogel layer, the lower the permeance. Therefore, a hydrogel layer needs to be as thin as possible without significant defects, regardless of its intended use.

Cross-linked PEO (XLPEO) hydrogel membranes are also promising for use in gas separation and natural gas upgrading.¹⁵⁻¹⁸ It has been shown that XLPEO films have good, stable CO₂/CH₄ selectivity in gas separation applications, combined with high thickness-normalized permeability to CO₂. However, existing membranes are tens of microns in thickness, resulting in low flux.

Despite the advantages of hydrogels, applying them as ultra-thin layers is challenging. Many researchers focus their studies on thick (10 s of μm) layers that have low flux.¹⁹ Others create TFC membranes by either coating⁶⁻⁷ or grafting.^{6,8} In each case, there are significant challenges to be overcome.

Membrane selective layers can be formed by coating. Hydrogel coatings have been formed on porous and TFC membranes to prevent fouling.^{6,20} Previous studies focused on cross-linked PVA²¹ and PEG-based hydrogels,²²⁻²³ though layers that include charged²² and/or zwitterionic²⁴ monomers have also been reported. To create a hydrogel coating, a monomer or pre-polymer solution is spread on the membrane (e.g., by doctor blading) and then cross-linked by UV exposure in the presence of a photoinitiator.^{14,21-26} This approach requires a high viscosity monomer/pre-polymer solution and specific wetting properties to achieve a good coating that remains on top of the membrane. These requirements make various coating formulations unusable. Viscosity can be increased with additives, but this can simultaneously change the pore size.^{14, 22-23} Achieving very thin (<0.5 μm) defect-free coatings using this method in large scale is also very difficult. Spin-coating can form thinner layers, but is not scalable to a roll-to-roll process.^{21, 25}

Further, membrane selective layers can also be formed by grafting. Grafting from membrane surfaces is another widely used membrane surface modification method.^{6,20} This method relies on creating groups that initiate polymer growth on the membrane surface. The groups can be created by plasma treatment,²⁷⁻²⁹ UV irradiation,³⁰⁻³⁹ or via attachment of initiating groups on the surface for atom transfer radical polymerization (ATRP)⁴⁰⁻⁴¹ or for photo-polymerization.⁴²⁻⁴³ The membrane is then exposed to a monomer to grow polymer chains. Typically, this approach creates a polymer brush lining the membrane pores and surface rather than a continuous selective layer.^{8,44} Some studies have reported forming continuous cross-linked and hydrogel layers on membranes by adding poly-functional monomers.³⁵⁻³⁹ To form a selective layer using this method, the pore diameter has to be spanned by growing polymer chains from a limited number of initiating sites on pores followed by cross-linking. This can require long reaction times and is prone to defects due to pore size polydispersity in the support membrane. Grafting—from approaches are also not typically amenable to incorporating functional nanomaterials into the selective layer.

Finally, membrane selective layers can be formed by interfacial polymerization. Commercial desalination and nanofiltration membranes today are prepared by a process called interfacial polymerization. These membranes have cross-linked polyamide selective layers that are very thin, and are manufactured by methods that are broadly based on those disclosed in U.S. Pat. Nos. 3,926,798 and 4,039,440.⁴⁵⁻⁴⁶ This process involves the preparation of a very thin selective layer by the condensation polymerization of two classes of highly reactive monomers.

This process can only work, however, for addition polymerization of an AA-type monomer (e.g. diamine) and a BB-type monomer (e.g. diacyl chloride) with mismatched solubility. It cannot be applied to polymers prepared by free radical polymerization, e.g. acrylates, methacrylates, and styrenes.

Interfacial free radical polymerization has been previously used to create liquid filled droplets for various applications.^{10, 47-49} However, this approach has not been used in a planar/flat or cylindrical geometry, or in a system that includes a porous support.

The need exists for better methods to produce thin hydrogel selective layers.

### SUMMARY

To meet this need, a novel method is provided for coating a porous support with a membrane selective layer. The method is carried out by (i) immersing a porous support in a first solution such that the first solution is absorbed into the pores, the first solution containing a monomer, (ii) removing the porous support from the first solution, (iii) covering the porous support with a second solution immiscible with the first solution, the second solution containing a polymerization initiator, (iv) activating the initiator to effect polymerization of the monomer, thereby forming a membrane selective layer on the porous support, and (v) washing the porous support having the membrane selective layer.

A porous support membrane is soaked in a first solvent (e.g. water) in which one or more monomers are dissolved. The porous support membrane is then covered with a solvent immiscible with the first (e.g. oil) that contains the initiator. Polymerization occurs upon the activation of the initiator (e.g. with exposure to UV irradiation). The resultant membrane features a membrane selective layer that can be very thin (e.g., less than 200 nm), prepared from a polymer that is difficult to apply by coating methods typically employed in the field. The selective layer can include multiple types of monomer, and is typically cross-linked through the presence of a di- or multi-functional co-monomer. The membranes can be used in bioseparations (e.g. protein purification, concentration and purification of biopharmaceuticals), water and wastewater treatment, or gas separation (e.g. natural gas upgrading).

The details of one or more embodiments of the invention are set forth in the drawings and description below. Other features, objects, and advantages of the invention will be apparent from the description, from the drawings, and from the claims.

### BRIEF DESCRIPTION OF THE DRAWINGS

The description below refers to the accompanying drawings, of which:

FIG. 1 is a schematic showing an embodiment of the claimed method;

FIG. 2 depicts a mechanism of free-radical polymerization (FRP);

FIG. 3 shows a proposed mechanism of interfacial FRP to form thin hydrogel selective layers;

FIGS. 4A-4F are scanning electron micrographs showing the morphology of (4A) polysulfone (PS) support, (4B) higher magnification of PS support, (4C) hydrogel layer at 5 min UV exposure time, (4D) higher magnification of hydrogel at 5 min UV exposure time, (4E) hydrogel layer after 10 min UV exposure time, and (4F) hydrogel layer at 10 min UV exposure time at higher magnification;

FIG. 5A shows chemical structures of polyethylene glycol diacrylate and PS;

FIG. 5B shows ATR-FTIR spectra of PS support membrane (bottom) and coated membrane (top) with an ultra-thin hydrogel layer with 5 min UV exposure;

FIG. 6 is a plot of membrane permeance versus UV exposure time when preparing membranes using a monomer solution containing 5% PEGDA and 2.5% PEG200 in water;

FIG. 7 is a plot of rejection fraction (%) versus protein molecular weight;

FIG. 8 is a plot of membrane permeance versus PEGDA concentration;

FIGS. 9A and 9B show scanning electron micrographs of (9A) membranes prepared with PEGDA concentration of 10 v/v % at 5 min UV exposure time and (9B) higher magnification of 9A; and

FIG. 10 is a plot of water flux versus time filtering a BSA solution.

### DETAILED DESCRIPTION

As mentioned above, the disclosed method is carried out by immersing a porous support in a first solution containing a monomer such that the first solution is absorbed into the pores. The porous support can be, but is not limited to a hollow fiber or a sheet membrane.

The porous support, after removing it from the first solution, is covered with a polymerization initiator-containing second solution immiscible with the first solution. In a particular embodiment, the first solution is an aqueous phase and the second solution is an organic phase. In an alternative embodiment, the first solution is an organic phase and the second solution is an aqueous phase.

The initiator can be, e.g., a photo-initiator, a thermal initiator, and a two-part redox initiator.

Following activation of the initiator, polymerization of the monomer occurs, thereby forming a membrane selective layer. The layer can contain, e.g., polyacrylate, polymethacrylate, and polyacrylamide. In a particular embodiment, the membrane selective layer contains a polymer formed from polyethylene glycol diacrylate.

The first solution described above, which contains the monomer, can also contain a co-monomer or a porogen.

Also provided is a membrane that includes a porous support coated by means of the above method with a membrane selective layer, in which the selective layer is less than 200 nm in thickness (e.g., less than 100 nm).

In a particular embodiment, the membrane has as a porous support a polysulfone membrane and the monomer polymerized to form the membrane selective layer is polyethylene glycol diacrylate.

Therefore, there is an urgent need in the membrane field for methods to form ultra-thin selective layers of a wider array of polymer compositions, especially hydrogels, to access broader parameter space.

The method of the invention is a new approach to form thin hydrophilic polymer selective layers on membranes by free-radical polymerization of water-soluble monomers initiated at an organic solvent-water interface spanning the surface of a support membrane (see FIG. 1). The method can create very thin (less than 200 nm), defect-free membrane selective layers and coatings from a wide array of water-soluble monomers (e.g., acrylates, methacrylates, and acrylamides) in a robust, highly scalable process, stemming from the limited solubility of the initiator in the monomer layer and the interfacial tension between the aqueous and oil layers creating a uniform, continuous interface.

In a method of the invention, a support membrane is immersed in an aqueous solution of the monomer (e.g. a hydrophilic acrylate or diacrylate). The membrane is removed, and immersed in a hydrophobic organic solvent (e.g., hexadecane) containing an oil-soluble free radical photo-initiator. The oil spreads over the membrane. Interfacial tension helps create a continuous, even layer. Upon illumination with ultraviolet (UV) light, the photo-initiator dissociates. The radicals thus created initiate polymerization at the interface. Polymer layer grows from the interface inward. By controlling simple, readily accessible parameters such as monomer and initiator concentrations, as well as illumination time and intensity, a wide range of structural and functional traits can be imparted and controlled. For example, the coating can include multiple co-monomers for added functionality or to modify selectivity, e.g., charged groups to enhance charge-based selectivity.

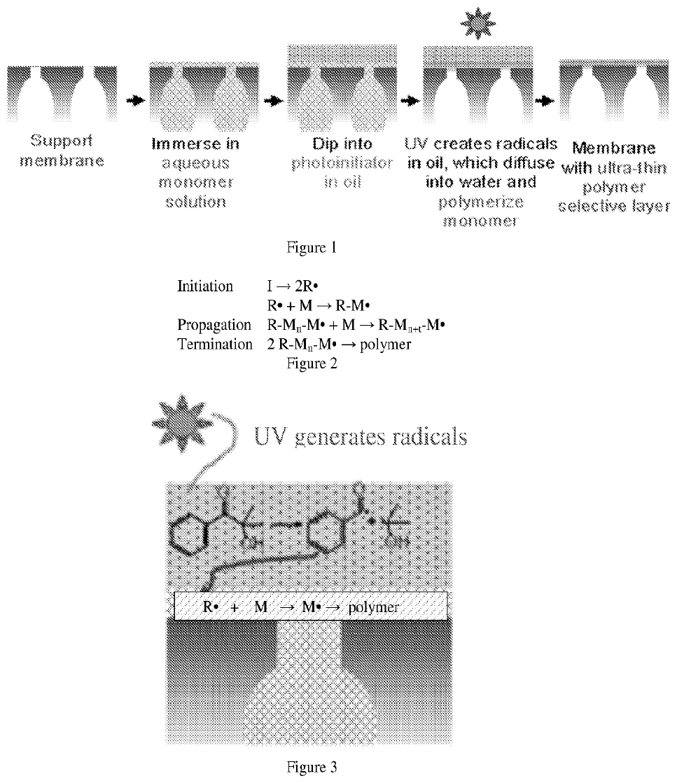

Substantially different from traditional methods, the method of this invention (i.e., interfacial FRP) features that it segregates reagents needed for FRP into two different phases: Monomers (M) in an aqueous phase inside and on the surface of membrane pores, and the photoinitiator (I) in an oil phase covering this layer (see FIGS. 2 and 3). The photoinitiator splits into two free radicals upon exposure to UV light. These radicals diffuse to the water interface and react with the monomers to initiate polymerization. Polymerization terminates when two growing chains meet. This means that the polymer layer starts forming at and growing from the oil/water interface. The polymer layer can be a cross-linked hydrogel if polyfunctional monomers are used. It can contain multiple types of water-soluble monomers, functional nanoparticles, and other components, each of which can be dissolved/suspended in the aqueous phase. The aqueous phase does not need to have a minimum viscosity. Interfacial tension between the water and oil phases prevent defects and creates a uniform selective layer.

The method set forth, supra, enables ultra-thin coatings from a wide range of monomer solution viscosities, is fast and easily scalable to roll-to-roll processing, and can incorporate functional nanomaterials into the coatings.

The above method can use as a monomer a solution that contains, e.g., polyethylene glycol diacrylate, poly(ethylene oxide) diacrylate, or poly(ethylene oxide) dimethacrylate, with or without additional co-monomers.

Co-monomers that can be used include, e.g., amine-containing acrylates, zwitterionic acrylates, amine-containing methacrylates, zwitterionic methacrylates, and PEG monoacrylate.

Non-reactive components, termed porogens, can be added to tune the properties of the membrane selective layer. The porogen can be polyethylene glycol (PEG) or other compounds such as salts. For example, PEGs (PEG200 with a molar mass of 200 Da and PEG600 with a molar mass of 600 Da) can be used as porogens.

Membranes prepared by the method described herein can have (i) an effective pore size smaller than that of the porous support, (ii) a molecular weight cut off between 1000 Da and 100,000 Da, and (iii) a fouling resistance superior to that of the porous support. In this case, the pore size of the membrane does not necessarily have to be smaller than the pore size of the porous support.

The above method can be adapted to be employed on an existing ultrafiltration, desalination, or nanofiltration membrane by coating it to prevent fouling.

Also encompassed by the invention is (i) a process for liquid filtration that utilizes the above membrane to concentrate a solution containing a biopharmaceutical compound, (ii) a process for liquid filtration that utilizes the above membrane to fractionate an aqueous solution containing one or more proteins, (iii) a process for liquid filtration in which the above membrane is used to treat wastewater, (iv) a process for liquid filtration in which the above membrane is used to treat nautral water sources such as surface water and ground water, (v) a process for gas separation in which the above membrane is used to preferentially permeate one component of a gas mixture over another, and (vi) a process for gas separation in which the above membrane is used to treat natural gas by removing CO₂, H₂S and/or other compounds from methane.

Without further elaboration, it is believed that one skilled in the art can, based on the description above, utilize the present invention to its fullest extent. The specific examples below are to be construed as merely illustrative, and not limitative of the remainder of the disclosure in any way whatsoever. All references cited herein are hereby incorporated by reference in their entirety.

### EXAMPLES

### Example 1: Fabrication of Membranes with Ultra-Thin Hydrogel Layers

A support membrane (Polysulfone, PS, Nanostone) was taped along all edges onto a glass plate. An aqueous solution containing 5-20 v/v % poly(ethylene glycol diacrylate (PEGDA, 700 g/mol), with or without a porogen or co-monomer, was poured on top of the support membrane. Porogens tested included short chain poly(ethylene glycol) (PEG) polymers, PEG200 (200 g/mol) or PEG600 (600 g/mol). Co-monomers tested included polyethylene glycol methyl ether acrylate (PEGMEA), sulfobetaine methacrylate (SBMA), and (3 acrylamidopropyl) trimethylammonium chloride (APTMAC). The support membrane was equilibrated with the aqueous monomer solution for 3 min. to provide enough time for monomers, co-monomers, and porogens to diffuse into the pores. The aqueous solution was then poured out and the membrane surface was gently dabbed using a filter paper to remove any residual droplets. A solution of 0.1 v/v % of the oil-soluble photoinitiator Darocur in n-hexadecane was poured on membrane surface. The membrane surface was covered by a glass plate to prevent photoinitiation from PS base membrane. PS is photosensitive and exposure to UV light creates radical on the PS backbone, but the use of the glass plate can filter out wavelengths that lead to this process as reported in previous studies.⁵³⁻⁵⁴ Subsequently, the membrane was exposed to 365 nm UV light with an 8 W hand-held UV lamp (Spectronics Corp., Westbury, N.Y.) for varying times (4-20 min.). The organic solution covering the membrane was then poured out and the membrane surface was washed with a water/ethanol mixture several times. The membrane was kept in DI water overnight to ensure the complete removal of unreacted monomer, porogen residues, and hexadecane.

### Example 2: Characterization of Hydrogel Layer Structure

The membranes prepared in EXAMPLE 1 above were imaged by field emission scanning electron microscopy (FE-SEM) using a Supra 55 FE-SEM at 4 kV and 7 mm working distance. The membranes were dried and frozen in liquid nitrogen and cut with a razor blade for cross-sectional imaging. They were sputter-coated with 3 nm of Au/Pd to prevent charging.

FIGS. 4A and 4B show the unmodified support membrane, a commercial polysulfone (PS) membrane with nominal molecular weight cut-off (MWCO) of 20 kDa. Typical of asymmetric ultrafiltration membranes, the membrane had smaller pores on top and larger macrovoids in the sublayers. FIG. 4C shows a membrane prepared using the procedure described in EXAMPLE 1, using a monomer solution containing 5% v/v PEGDA and a UV exposure time of 5 min. A continuous, very thin hydrogel layer covering the support structure could be seen. A higher magnification image of this membrane (FIG. 4D) shows the presence of the layer more clearly. The selective layer was very thin with a thickness of less than 100 nm (about 80 nm; FIG. 4D). FIG. 4E shows a membrane prepared using the same monomer solution with a longer UV exposure time of 10 min. A more distinct layer was seen compared with the shorter irradiation time of 5 min. Longer UV exposure time increased the dry thickness of the hydrogel layer. Notably, the layer appeared to be uniform throughout the membrane. This uniform layer was maintained throughout the entire membrane sample, imaged in different frames sampling the length of the swatch, indicating the consistent nature of the inventive method. A higher magnification image of this membrane (FIG. 4F) shows a uniform structure of the layer across the layer thickness of about 130 nm. Longer UV exposure yields higher layer thickness.

### Example 3: Hydrogel Layer Surface Chemistry Analysis

Attenuated Total Reflection-Fourier Transform Infrared (ATR-FTIR) spectroscopy was used to examine the chemical structure of the selective layers formed on PS membranes as prepared in EXAMPLE 1. The ATR-FTIR spectra were acquired using a Jasco FT/IR-6200 spectrophotometer over the range of 4000-600 cm⁻¹ at a 2 cm⁻¹ resolution. Prior to analysis, membranes were air-dried for 24 h.

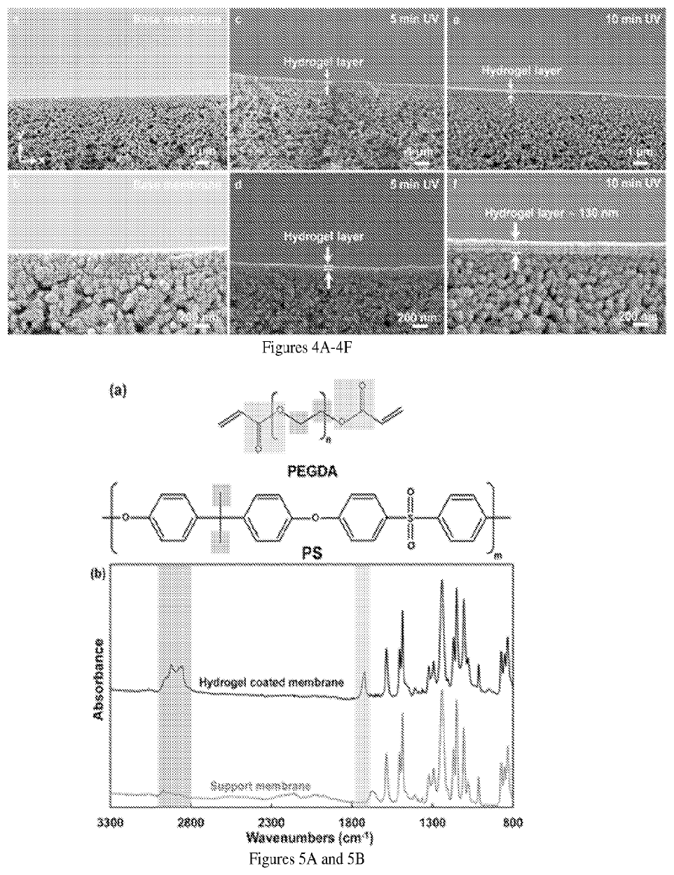

PEGDA (FIG. 5A) formed a crosslinked PEG network upon photo-initiated free radical polymerization on the membrane surface. This led to an increase in the frequency of C—H bonds in comparison with the support membrane material PS, and also introduced ester groups. These changes could be seen by comparing the ATR-FTIR spectrum of the coated membrane with the support membrane (FIG. 5B).

Upon the deposition of the cross-linked PEG selective layer, the broad absorbance peak around 2800-3000 cm⁻¹ corresponding to the C—H stretching vibration increased in intensity.⁵⁷⁻⁵⁸ This peak was very weak in the support membrane, which did not contain as high a concentration of C—H groups (FIG. 5A). The presence and chemical structure of the coating layer was also confirmed by the appearance of the C═O stretching peak at 1723 cm⁻¹ arising from the ester bond at each end of the PEGDA (FIG. 5B).⁵⁷ The coating showed no significant absorbance at 1620-1640 cm⁻¹. This wavelength range corresponded to the vinyl groups in PEGDA that are converted to single bonds upon polymerization.⁵⁷ The lack of a peak in this range in the spectrum of the coated membrane suggests that the formed hydrogel layer was mostly or fully polymerized, mostly free of un-polymerized or partially polymerized PEGDA monomer.

### Example 4: Effect of UV Exposure Time on Hydrogel Membrane Permeance

Permeance was measured by filtering pure water through the membranes prepared in EXAMPLE 1. Studies were performed using an Amicon 8010 stirred, dead-end filtration cell (Millipore) with a cell volume of 10 mL and an effective filtration area of 4.1 cm². The cell was stirred at 500 rpm. Tests were performed at an applied trans-membrane pressure of 40 psi. Water flow rate through the membranes was measured by collecting the permeate in a container placed on top of a scale and observing the total weight increase over time. The membrane permeance (Lₚ) was calculated by normalizing flux (J), defined as the water flow rate divided by active membrane area, with applied trans-membrane pressure (ΔP):

$${L}_{p} = \frac{J}{Δ P} = \frac{1}{{R}_{total}} \qquad Equation 1$$

The support membrane was measured to have a water permeance of about 1253±62 L h⁻¹ m² bar⁻¹.

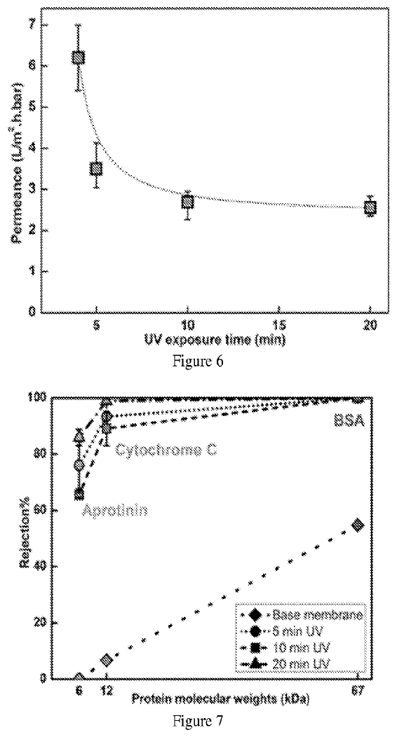

Support membranes were coated with a hydrogel as above using a monomer solution containing 5 v/v % PEGDA and 2.5 v/v % PEG200 at different UV exposure times (4-20 min.). The water permeance of these membranes is shown in FIG. 6.

The membrane prepared with the shortest UV exposure time of 4 min. had a substantially lower permeance than the support membrane, 6.2 L h⁻¹ m⁻² bar⁻¹. This indicates that the hydrogel layer was properly formed. Membranes prepared with 5 min. UV exposure time had a permeance of 3.5 L h⁻¹ m⁻² bar⁻¹, while 10 min. and 20 min. UV exposure showed similar permeances of about 2.6 L h⁻¹ m⁻² bar⁻¹. All four conditions tested showed consistent and substantially lower permeance over that of the support membrane, indicating the formation of the hydrogel layer. Longer UV exposure initially led to lower permeance, but the values reached a plateau after 10 minutes, indicated by the dotted line in FIG. 6 (B-Spline fitting). A minimum UV exposure time (greater than 4 min.) appeared to be needed to ensure formation of uniform hydrogel layer with permeation properties that are distinctively different from the support membrane. Shorter exposure times led to membranes with permeances comparable with the support membrane. These permeance results correlated well with and further confirmed the morphological results acquired via SEM as shown in FIG. 4. The membrane featuring a thinner hydrogel layer (5 min., FIG. 4D) exhibited 40% higher permeance than the ones with thicker layers (20 min., FIG. 4F).

The error bars shown in FIG. 6 represent the maximum and minimum permeance values measured during the test of at least 5 samples prepared for each condition. The narrow range of resultant permeances, indicated by tight error bars, shows the robust and reliable nature of the disclosed method.

The permeance range discussed above is comparable to commercial tight ultrafiltration (UF) thin film composite (TFC) membranes, typically designed for nominal molecular weight cut-off (MWCO) values between 1000-3000 Da. For example, according to industrial specification sheets, UF membranes manufactured by GE with nominal MWCOs between 1000-3000 Da have permeances between 1.12-5.65 Lm⁻² h⁻¹ bar^{-1.59} Furthermore, most commercial membranes are prone to severe fouling upon exposure to solutions containing organic macromolecules (e.g. proteins, polysaccharides) and oil. This method enables the preparation of membranes with highly hydrophilic hydrogel selective layers that resist fouling.

### Example 5: Membrane Performance in Protein Filtration

Solutions of different proteins were filtered through the membranes produced as described in EXAMPLE 1 using the filtration equipment and procedures described in EXAMPLE 4. Each protein was dissolved in phosphate buffered saline (PBS) at a concentration of 100 mg/L. The membranes were first compacted by filtering deionized water through them for at least 3 hours. A protein solution was then placed in the filtration cell, and filtered through the membrane at a trans-membrane pressure of 40 psi. The first 1 mL of the filtrate was discarded, and the subsequent 1 mL was collected. The concentration of the protein in this filtrate was measured using UV-visible spectroscopy (Thermo Scientific Genesys 10S). Protein rejection was calculated according to:

$$R \% = ( 1 - \frac{{C}_{p}}{{C}_{F}} ) \times 100 \qquad Equation 2$$

where R is solute rejection, and C_{F} and C_{P} are the concentration of feed (100 ppm) and permeate, respectively. The following three proteins with different molecular weights and hydrodynamic radii (R_{H}) were tested: (i) Aprotinin (6.5 kDa, R_{H}˜1.3 nm), (ii) Cytochrome C (12 kDa, R_{H}˜1.7 nm), and (iii) Bovine Serum Albumin (BSA, 66 kDa, R_{H}˜3.5 nm).⁶⁰

The rejection of these three proteins by the support membrane and by three hydrogel-coated membranes prepared with varying UV exposure time (5, 10, and 20 min.) was tested. The hydrogel-coated membranes were prepared using an aqueous monomer solution containing 5 v/v % of PEGDA and 2.5 v/v % PEG200. The results are shown in FIG. 7.

The support membrane exhibited negligible rejection for the two smaller proteins, and a 55% rejection of the larger BSA. This is consistent with a MWCO above 67 kDa. MWCO of a membrane is typically defined as the molecular weight of a solute rejected by 90%. All three hydrogel coated membranes exhibited much higher rejection of all three proteins, confirming the formation of a selective layer that controls membrane selectivity. They all showed moderate rejection (65-85%) for the smallest protein tested, i.e., aprotinin. The larger cytochrome C showed higher rejection of 90-99.9%. BSA, the largest protein tested, was completely rejected (>99%) by all three tested hydrogel-coated membranes. This data is consistent with a MWCO of around 8-10 kDa. All three hydrogel coated membranes had roughly similar rejections, within error margins of each other. The data suggests that UV exposure time mainly affects hydrogel layer thickness and not membrane pore size. The significant enhancement of the rejection properties of the membrane confirms that the inventive method leads to formation of a uniform and defect-free selective layer on the support membrane.

### Example 6: Alteration of Membrane Permeance and Selectivity Through Changes in Monomer Solution Composition

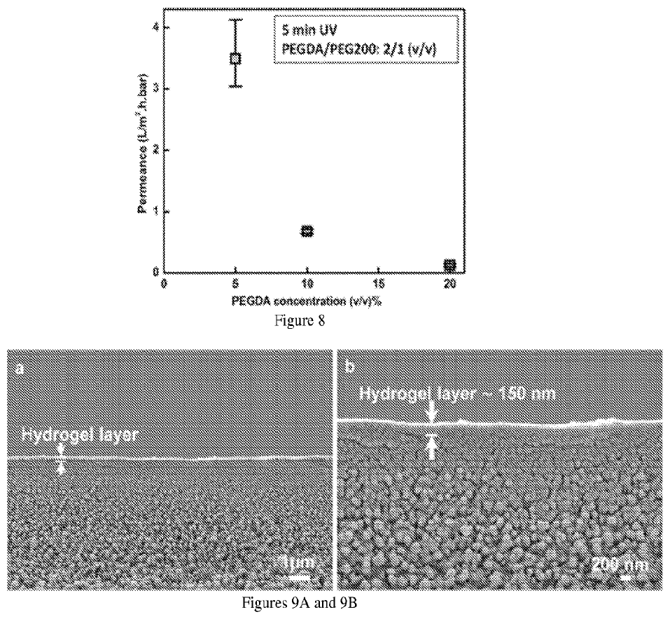

Membranes were prepared by the method set forth above in EXAMPLE 1 using aqueous solutions of PEGDA at varying concentrations (5, 10, and 20 v/v %) with PEG200 as an additive at a 2:1 PEGDA:PEG200 volume ratio, and a 5-minute UV exposure time. Membrane permeance was measured as described above. The results are shown in FIG. 8.

Increasing monomer concentration in the solution led to significant declines in permeance. Membranes prepared from 10 v/v % PEGDA solutions had a permeance of 0.7 L m⁻² h⁻¹ bar⁻¹, compared with a permeance of 3.5 L m⁻² h⁻¹ bar⁻¹ for a membrane prepared from a 5 v/v % PEGDA solution. The permeance further decreased to 0.1 L m⁻² h⁻¹ bar⁻¹ upon increasing the PEGDA content to 20 v/v %.

Not to be bound by theory, the decrease in membrane permeance could be attributed to formation of a thicker hydrogel layer at higher PEGDA content. An exemplary electron micrograph of a membrane prepared from 10 v/v % PEGDA (see FIG. 9) showed a hydrogel layer about 150 nm in thickness. Higher monomer concentrations also likely lead to a higher crosslink density, thereby resulting in a decrease in hydrogel mesh size. These results further demonstrate that hydrogel coated membrane pore size can be tuned by varying PEGDA content.

### Example 7: Alteration of Membrane Permeance and Selectivity Via Porogens and Co-Monomers

In addition to the change in PEGDA concentration, hydrogel pore size could also be altered using an inert porogen such as low molecular weight PEG. The addition of PEG to the monomer solution can potentially decrease the cross-link density.

Membranes were prepared as described in EXAMPLE 1 with the addition to the PEGDA aqueous monomer solution of short chain PEG oligomers at two different molar masses (PEG200 with a molar mass of 200 Da, PEG600 with a molar mass of 600 Da) and at varying concentrations (0-30 v/v %). A UV exposure time of 5 min. was used. The permeance through the resulting membranes of pure water, as well as that of BSA and Cytochrome C, was measured as described above. The results are shown in Table 1 below.

TABLE 1
Membrane Permeances and Protein Rejection^{a}

| | Permeance | BSA | |
|---|---|---|---|
| | (L/m² · | Rejection | Cytochrome C |
| Additives | h · bar) | % | Rejection % |
| 5% PEGDA | 1.9 ± 0.3 | >99^{b} | 92.5 ± 1.1 |
| 5% PEGDA/2.5% PEG200 | 3.5 ± 0.5 | >99 | 93.4 ± 2.0 |
| 5% PEGDA/10% PEG200 | 5.9 ± 0.4 | >99 | 96.7 ± 1.3 |
| 5% PEGDA/20% PEG200 | 3.8 ± 1.2 | >99 | 94.9 ± 0.9 |
| 5% PEGDA/30% PEG200 | 6.3 ± 1.6 | 85 ± 2 | 71 ± 7 |
| 5% PEGDA/30% PEG600 | 8.1 ± 1.5 | 70 ± 7 | 65 ± 9 |
| 5% PEGDA/2.5% PEGMEA | 2.6 ± 0.7 | >99 | 95.0 ± 0.6 |
| 7.5% PEGDA | 1.1 ± 0.3 | >99 | 99.5 ± 0.3 |

^{a}Error margins indicate standard deviation from at least three samples.
^{b}Detection limit.

The results indicated that adding small amounts of PEG200 increased the permeance without influencing the rejection properties of proteins. Increasing the amount of PEG200 to 10 v/v % increased the membrane permeance by about 3-fold compared to the membrane prepared without a porogen. At the same time, the rejection of Cytochrome C did not decline and even exhibited a minor increase.

Upon further addition of PEG200 (20% v/v), the permeance decreased, yet similar rejection properties were obtained. However, when 30% v/v PEG200 was used in the monomer solution, the resultant permeance was about 3 times the value for the membrane prepared without adding any PEG200. This was accompanied with a decrease in the rejection of both BSA and Cytochrome C. This is likely due to the formation of interconnected pores by polymerization-induced phase separation (PIPS) at the high concentration of PEG200. Inert additives such as PEG oligomers could also interfere with the polymerization reaction when present at high concentrations. This could also have resulted in the observed decrease in protein rejection.

PEG600 has been documented to create larger pores in cross-linked PEG gels by causing polymerization induced phase separation.¹¹ Adding 10-20% PEG600 led to similar permeance and rejection properties to those obtained with similar amounts of PEG200. However, when the PEG600 concentration was increased to 30 v/v %, the membrane permeance increased more than two-fold (compared to, e.g., 20% PEG600), accompanied by a decrease in the rejection of both BSA and Cytochrome C, indicating the presence in the membrane of larger pores. The formation of larger pores by PEG600 can be attributed to the PIPS. The larger molar mass of PEG600 led to more significant PIPS in comparison with PEG200.¹¹ This shows that the hydrogen network can be easily tuned using different porogens.

Cross-link density can also be altered through the use of a mono-functional co-monomer such as poly(ethylene glycol) methyl ether acrylate (PEGMEA, 480 g/mol) mixed with PEGDA in the monomer solution.⁵⁵ The results in the two bottom rows of Table 1 show that copolymerization of PEGMEA with PEGDA led to a higher membrane permeance in comparison with a membrane made with PEGDA only (7.5% v/v). BSA is fully retained by both membranes, whereas the rejection of smaller Cytochrome C decreases somewhat, indicating a slight increase in the effective pore size of the membrane. The replacement of some PEGDA with PEGMEA would decrease the cross-link density and increase the mesh size.^{56,63} The results (see Table 1) indicated that copolymerization of PEGMEA with PEGDA slightly increased the membrane permeance, but did not alter the rejection of Cytochrome C. This may arise from the fact that PEGMEA also participates in the polymerization reaction (unlike PEG200 or PEG600), which increased the effective monomer concentration in solution and hence led to a higher cross-link density.

The results demonstrated that permeance and mesh size of selective layers can be altered in a controlled fashion. The narrow standard deviations shown in Table 1 demonstrate the consistency and robustness of the method of the invention.

### Example 8: Hydrogel Fouling Properties

The fouling properties of a membrane prepared using the above method was investigated by a filtration experiment. This test was performed in a cross-flow filtration system with a flat-frame membrane module (Sterlitech CF016A, Kent, Wash.) integrated with a KrosFlo® Research II TFF System (Spectrum Laboratories, Inc., Compton, Calif.). The CF016 cell, with an as-manufactured effective membrane area of 20.6 cm² and a channel depth of 2.3 mm, was fitted with an impermeable plastic mask that allowed the installation of round membrane swatches with an effective filtration area of 4.1 cm². Experiments were performed at trans-membrane pressure (TMP) of 40 psi and feed flow rate of 135 ml/min, corresponding to a shear rate of 9.4 s⁻¹.

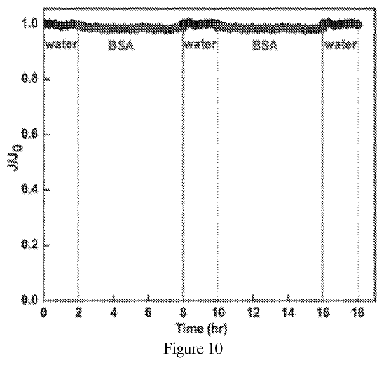

Initially, water was filtered through the hydrogel-coated membrane to document the initial water flux. This value (termed Jo) was measured to be 12.5 L m⁻² h⁻¹. Then, a solution of 100 ppm BSA in PBS was filtered through the membrane for 6 h. After this, the membrane was cleaned with DI water, and water was filtered again. This cycle was repeated. The results are shown in FIG. 10.

The membrane not only showed no decline in its water flux that could not be recovered by a water rinse after the protein filtration, but also maintained high flux during the filtration with >99% rejection of BSA.

### Example 9: Membranes for Gas Separation

Membranes prepared using the method described in EXAMPLE 1 using various monomer solution compositions were tested for their performance in gas separation. More specifically, the capacity of the membrane to selectively permeate CO₂ and other polar gases preferentially over non-polar gases such as N₂ and CH₄ was measured. Membranes were prepared as described above using aqueous monomer solutions containing PEGDEA together with different co-monomers (e.g. polyethylene glycol methyl ether acrylate (PEGMEA), sulfobetaine methacrylate (SBMA), (3 acrylamido-propyl) trimethylammonium chloride (APTMAC)) or inert additives (PEG200, PEG600) with a UV irradiation time of 5 min. The permeances of two gases, N₂ and CO₂, were measured in single gas permeation experiments. The membrane was placed in an in-line filter holder with a 1-inch diameter (Cole-Parmer, Vernon Hills, Ill.). Each gas was fed to the membrane at a trans-membrane pressure of 60 psi. The flow rate of the gas was measured using a bubble flow meter. The results are shown below in Table 2.

TABLE 2
Effect of co-monomer/additive in prepolymer solution
on membrane efficiency for CO₂/N₂ Separation

| | | Permeance | | |
|---|---|---|---|---|
| PEGDA | Co-monomer/ | (mol/m² · s · Pa) | | |
| v/v % | Additive | N₂ | CO₂ | α_{CO2/N2} |
| 0 | 0 | 2.3E−8 | 1.6E−7 | 7 |
| 5 | 2.5% PEG200 | 2.2E−10 | 4.8E−9 | 21.8 |
| 5 | 2.5% PEGMEA | 1.8E−10 | 4.6E−9 | 26.3 |
| 2.5 | 5% PEGMEA | 2.2E−10 | 9.9E−9 | 45.0 |
| 1 | 6.5% PEGMEA | 7.2E−10 | 9.9E−10 | 13.7 |
| 1.5 | 3% PEGMEA | 2.3E−10 | 7.2E−9 | 31.0 |
| 5 | 30% PEG600 | 3.5E−10 | 5.3E−9 | 15.2 |
| 2.5 | 5% APTMAC | 3.3E−10 | 4.3E−9 | 13.0 |
| 2.5 | 0.1 wt % SBMA | 3.0E−10 | 3.8E−9 | 12.6 |
| 2.5 | 5 wt % SBMA | 4.8E−9 | 5.3E−8 | 11.0 |

The tested membranes exhibited a wide range of CO₂/N₂ selectivities, all significantly higher than that shown by the base membrane and that predicted by the Knudsen model for nanoporous materials. This indicated that the membranes were highly defect-free, as even small pinhole defects tend to severely impact gas separation selectivity. The highest selectivity obtained was 45, comparable to that of thick cross-linked PEGDA membranes containing PEGMEA reported in the literature.^{16,18, 64-66} Yet, the permeances of the tested membranes was an order of magnitude higher than those reported previously for thicker membranes.

### REFERENCES

1. Shannon, M. A.; Bohn, P. W.; Elimelech, M.; Georgiadis, J. G.; Marinas, B. J. Mayes, A. M., Science and technology for water purification in the coming decades. Nature 2008, 452, 301-310.
2. Asatekin, A. Mayes, A. M., Polymer filtration membranes. In Encyclopedia of Polymer Science and Technology, John Wiley & Sons: New York, 2009.
3. Baker, R. W., Membrane technology and applications. 2nd ed.; J. Wiley: Chichester; New York, 2004; p x, 538 p.
4. Petersen, R. J., Composite Reverse Osmosis and Nanofiltration Membranes. Journal of Membrane Science 1993, 83 (1), 81-150.
5. Mohammad, A. W.; Teow, Y. H.; Ang, W. L.; Chung, Y. T.; Oatley-Radcliffe, D. L. Hilal, N., Nanofiltration membranes review: Recent advances and future prospects. Desalination 2015, 356, 226-254.
6. Yang, Q.; Adrus, N.; Tomicki, F. Ulbricht, M., Composites of functional polymeric hydrogels and porous membranes. Journal of Materials Chemistry 2011, 21 (9), 2783-2811.
7. van Rijn, P.; Tutus, M.; Kathrein, C.; Zhu, L.; Wessling, M.; Schwaneberg, U. Boker, A., Challenges and advances in the field of self-assembled membranes. Chemical Society Reviews 2013, 42 (16), 6578-6592.
8. Bhattacharya, A. Misra, B. N., Grafting: a versatile means to modify polymers—Techniques, factors and applications. Progress in Polymer Science 2004, 29 (8), 767-814.
9. Pross, A.; Platkowski, K. Reichert, K.-H., The inverse emulsion polymerization of acrylamide with pentaerythritolmyristate as emulsifier. 1. Experimental studies. Polym Int 1998, 45 (1), 22-26.
10. Jung, S. Yi, H., Facile Micromolding-Based Fabrication of Biopolymeric-Synthetic Hydrogel Microspheres with Controlled Structures for Improved Protein Conjugation. Chemistry of Materials 2015, 27 (11), 3988-3998.
11. Choi, N. W.; Kim, J.; Chapin, S. C.; Duong, T.; Donohue, E.; Pandey, P.; Broom, W.; Hill, W. A. Doyle, P. S., Multiplexed Detection of mRNA Using Porosity-Tuned Hydrogel Microparticles. Analytical Chemistry 2012, 84 (21), 9370-9378.
12. Elbert, D. L., Liquid-liquid two-phase systems for the production of porous hydrogels and hydrogel microspheres for biomedical applications: A tutorial review. Acta Biomaterialia 2011, 7 (1), 31-56.
13. Ju, H.; McCloskey, B. D.; Sagle, A. C.; Kusuma, V. A. Freeman, B. D., Preparation and characterization of crosslinked poly(ethylene glycol) diacrylate hydrogels as fouling-resistant membrane coating materials. Journal of Membrane Science 2009, 330 (1-2), 180-188.
14. Ju, H.; McCloskey, B. D.; Sagle, A. C.; Wu, Y. H.; Kusuma, V. A. Freeman, B. D., Crosslinked poly(ethylene oxide) fouling resistant coating materials for oil/water separation. J Membrane Sci 2008, 307 (2), 260-267.
15. Borns, M. A.; Kalakkunnath, S.; Kalika, D. S.; Kusuma, V. A. Freeman, B. D., Dynamic relaxation characteristics of crosslinked poly(ethylene oxide) copolymer networks: Influence of short chain pendant groups. Polymer 2007, 48 (25), 7316-7328.
16. Freeman, B. Pinnau, I., Separation of gases using solubility-selective polymers. Trends in Polymer Science 1997, 5 (5), 167-173.
17. Kalika, D. S.; Kalakkunnath, S.; Danquah, M. K.; Lin, H. Q.; Kusuma, V. A. Freeman, B. D., Influence of network structural modifications on the properties of crosslinked poly(ethylene oxide) copolymer membranes for CO2 separations. Abstracts of Papers of the American Chemical Society 2009, 237.
18. Lin, H. Q.; Freeman, B. D.; Kalakkunnath, S. Kalika, D. S., Effect of copolymer composition, temperature, and carbon dioxide fugacity on pure- and mixed-gas permeability in poly(ethylene glycol)-based materials: Free volume interpretation. Journal of Membrane Science 2007, 291 (1-2), 131-139.
19. Kang, G. D.; Cao, Y. M.; Zhao, H. Y. Yuan, Q., Preparation and characterization of crosslinked poly(ethylene glycol) diacrylate membranes with excellent antifouling and solvent-resistant properties. Journal of Membrane Science 2008, 318 (1-2), 227-232.
20. Yang, R.; Asatekin, A. Gleason, K. K., Design of conformal, substrate-independent surface modification for controlled protein adsorption by chemical vapor deposition (CVD). Soft Matter 2012, 8 (1), 31-43.
21. Li, R. H. Barbari, T. A., Performance of Poly(Vinyl Alcohol) Thin-Gel Composite Ultrafiltration Membranes. Journal of Membrane Science 1995, 105 (1-2), 71-78.
22. Nam, K. T.; Kim, D. W.; Yoo, P. J.; Chiang, C. Y.; Meethong, N.; Hammond, P. T.; Chiang, Y. M. Belcher, A. M., Virus-enabled synthesis and assembly of nanowires for lithium ion battery electrodes. Science 2006, 312 (5775), 885-888.
23. Allen, M.; Willits, D.; Mosolf, J.; Young, M. Douglas, T., Protein cage constrained synthesis of ferrimagnetic iron oxide nanoparticles. Advanced Materials 2002, 14 (21), 1562-1565.
24. Kim, K. K.; Hsu, A.; Jia, X. T.; Kim, S. M.; Shi, Y. M.; Dresselhaus, M.; Palacios, T. Kong, J., Synthesis and Characterization of Hexagonal Boron Nitride Film as a Dielectric Layer for Graphene Devices. Acs Nano 2012, 6 (10), 8583-8590.
25. Nykanen, A.; Nuopponen, M.; Laukkanen, A.; Hirvonen, S. P.; Rytela, M.; Turunen, O.; Tenhu, H.; Mezzenga, R.; Ikkala, O. Ruokolainen, J., Phase behavior and temperature-responsive molecular filters based on self-assembly of Polystyrene-block-poly(N-isopropylacrylamide)-block-polystyrene. Macromolecules 2007, 40 (16), 5827-5834.
26. La, Y. H.; McCloskey, B. D.; Sooriyakumaran, R.; Vora, A.; Freeman, B.; Nassar, M.; Hedrick, J.; Nelson, A. Allen, R., Bifunctional hydrogel coatings for water purification membranes: Improved fouling resistance and antimicrobial activity. Journal of Membrane Science 2011, 372 (1-2), 285-291.
27. Lee, Y. M. Shim, I. K., Plasma surface graft of acrylic acid onto a porous poly(vinylidene fluoride) membrane and its riboflavin permeation. J Appl Polym Sci 1996, 61 (8), 1245-1250.
28. Michel, V.; Marzin, C.; Tarrago, G. Durand, J., New membranes bearing pyridinic ligands by plasma graft polymerization. J Appl Polym Sci 1998, 70 (2), 359-366.
29. Tran, T. D.; Mori, S. Suzuki, M., Plasma modification of polyacrylonitrile ultrafiltration membrane. Thin Solid Films 2007, 515 (9), 4148-4152.
30. Taniguchi, M.; Kilduff, J. E. Belfort, G., Low fouling synthetic membranes by UV-assisted graft polymerization: monomer selection to mitigate fouling by natural organic matter. Journal of Membrane Science 2003, 222 (1-2), 59-70.
31. Ulbricht, M.; Matuschewski, H.; Oechel, A. Hicke, H. G., Photo-induced graft polymerization surface modifications for the preparation of hydrophilic and low-protein-adsorbing ultrafiltration membranes. Journal of Membrane Science 1996, 115 (1), 31-47.
32. Ulbricht, M.; Oechel, A.; Lehmann, C.; Tomaschewski, G. Hicke, H. G., Gas-Phase Photoinduced Graft-Polymerization of Acrylic-Acid onto Polyacrylonitrile Ultrafiltration Membranes. Journal of Applied Polymer Science 1995, 55 (13), 1707-1723.
33. Yang, B. Yang, W. T., Thermo-sensitive switching membranes regulated by pore-covering polymer brushes. Journal of Membrane Science 2003, 218 (1-2), 247-255.
34. Yu, H. J.; Cao, Y. M.; Kang, G. D.; Liu, J. H.; Li, M. Yuan, Q., Enhancing antifouling property of polysulfone ultrafiltration membrane by grafting zwitterionic copolymer via UV-initiated polymerization. Journal of Membrane Science 2009, 342 (1-2), 6-13.
35. Mao, C. B.; Flynn, C. E.; Hayhurst, A.; Sweeney, R.; Qi, J. F.; Georgiou, G.; Iverson, B. Belcher, A. M., Viral assembly of oriented quantum dot nanowires. Proceedings of the National Academy of Sciences of the United States of America 2003, 100 (12), 6946-6951.
36. Culver, J. N.; Brown, A. D.; Zang, F.; Gnerlich, M.; Gerasopoulos, K. Ghodssi, R., Plant virus directed fabrication of nanoscale materials and devices. Virology 2015, 479-480, 200-212.
37. Culver, J. N., Tobacco mosaic virus assembly and disassembly: Determinants in pathogenicity and resistance. Annual Review of Phytopathology 2002, 40, 287-308.
38. Balci, S.; Bittner, A. M.; Hahn, K.; Scheu, C.; Knez, M.; Kadri, A.; Wege, C.; Jeske, H. Kern, K., Copper nanowires within the central channel of tobacco mosaic virus particles. Electrochimica Acta 2006, 51 (28), 6251-6257.
39. Douglas, T. Young, M., Virus particles as templates for materials synthesis. Advanced Materials 1999, 11 (8), 679-681.
40. Li, Q.; Zhou, B.; Bi, Q.-Y. Wang, X.-L., Surface modification of PVDF membranes with sulfobetaine polymers for a stably anti-protein-fouling performance. J Appl Polym Sci 2012, 125 (5), 4015-4027.
41. Zhao, Y.-H.; Wee, K.-H. Bai, R., A Novel Electrolyte-Responsive Membrane with Tunable Permeation Selectivity for Protein Purification. Acs Applied Materials & Interfaces 2009, 2 (1), 203-211.
42. Lilly, J. L.; Romero, G.; Xu, W.; Shin, H. Y. Berron, B. J., Characterization of Molecular Transport in Ultrathin Hydrogel Coatings for Cellular Immunoprotection. Biomacromolecules 2015, 16 (2), 541-549.
43. Kizilel, S.; Pérez-Luna, V. H. Teymour, F., Photopolymerization of Poly(Ethylene Glycol) Diacrylate on Eosin-Functionalized Surfaces. Langmuir 2004, 20 (20), 8652-8658.
44. Carroll, T.; Booker, N. A. Meier-Haack, J., Polyelectrolyte-grafted microfiltration membranes to control fouling by natural organic matter in drinking water. Journal of Membrane Science 2002, 203 (1-2), 3-13.
45. Cadotte, J. E. Reverse osmosis membrane. U.S. Pat. No. 3,926,798, 1975.
46. Cadotte, J. E. Reverse osmosis membrane. U.S. Pat. No. 4,039,440, 1977.
47. Scott, C.; Wu, D.; Ho, C.-C. Co, C. C., Liquid-Core Capsules via Interfacial Polymerization: A Free-Radical Analogy of the Nylon Rope Trick. Journal of the American Chemical Society 2005, 127 (12), 4160-4161.
48. Wu, D.; Scott, C.; Ho, C.-C. Co, C. C., Aqueous-Core Capsules via Interfacial Free Radical Alternating Copolymerization. Macromolecules 2006, 39 (17), 5848-5853.
49. Piradashvili, K.; Alexandrino, E. M.; Wurm, F. R. Landfester, K., Reactions and Polymerizations at the Liquid-Liquid Interface. Chem Rev 2016, 116 (4), 2141-2169.
50. Cruise, G. M.; Hegre, O. D.; Scharp, D. S. Hubbell, J. A., A sensitivity study of the key parameters in the interfacial photopolymerization of poly(ethylene glycol) diacrylate upon porcine islets. Biotechnology and Bioengineering 1998, 57 (6), 655-665.
51. Sawhney, A. S.; Pathak, C. P. Hubbell, J. A., Modification of islet of langerhans surfaces with immunoprotective poly(ethylene glycol) coatings via interfacial photopolymerization. Biotechnology and Bioengineering 1994, 44 (3), 383-386.
52. Cruise, G. M.; Scharp, D. S. Hubbell, J. A., Characterization of permeability and network structure of interfacially photopolymerized poly(ethylene glycol) diacrylate hydrogels. Biomaterials 1998, 19 (14), 1287-1294.
53. Yamagishi, H.; Crivello, J. V. Belfort, G., Development of a Novel Photochemical Technique for Modifying Poly(Arylsulfone) Ultrafiltration Membranes. J Membrane Sci 1995, 105 (3), 237-247.
54. Pieracci, J.; Crivello, J. V. Belfort, G., Increasing membrane permeability of UV-modified poly(ether sulfone) ultrafiltration membranes. J Membrane Sci 2002, 202 (1-2), 1-16.
55. Wu, Y. H.; Park, H. B.; Kai, T.; Freeman, B. D. Kalika, D. S., Water uptake, transport and structure characterization in poly(ethylene glycol) diacrylate hydrogels. J Membrane Sci 2010, 347 (1-2), 197-208.
56. Sagle, A. C.; Ju, H.; Freeman, B. D. Sharma, M. M., PEG-based hydrogel membrane coatings. Polymer 2009, 50 (3), 756-766.
57. Peter, M. Tayalia, P., An alternative technique for patterning cells on poly(ethylene glycol) diacrylate hydrogels. Rsc Adv 2016, 6 (47), 40878-40885.
58. Xiao, Y. H.; He, L. Che, J. F., An effective approach for the fabrication of reinforced composite hydrogel engineered with SWNTs, polypyrrole and PEGDA hydrogel. J Mater Chem 2012, 22 (16), 8076-8082.
59. world-wide web at sterlitech.com/flat-sheet-membranes-specifications.html.
60. Talmard, C.; Guilloreau, L.; Coppel, Y.; Mazarguil, H. Faller, P., Amyloid-beta peptide forms monomeric complexes with Cu-II and Zn-II prior to aggregation. Chembiochem 2007, 8 (2), 163-165.
61. Jung, S. Yi, H., Facile Micromolding-Based Fabrication of Biopolymeric-Synthetic Hydrogel Microspheres with Controlled Structures for Improved Protein Conjugation. Chem Mater 2015, 27 (11), 3988-3998.
62. Jung, S.; Abel, J. H.; Starger, J. L. Yi, H., Porosity-Tuned Chitosan-Polyacrylamide Hydrogel Microspheres for Improved Protein Conjugation. Biomacromolecules 2016, 17 (7), 2427-2436.
63. Wu, Y.-H.; Park, H. B.; Kai, T.; Freeman, B. D. Kalika, D. S., Water uptake, transport and structure characterization in poly(ethylene glycol) diacrylate hydrogels. Journal of Membrane Science 2010, 347 (1-2), 197-208.
64. Borns, M. A.; Kalakkunnath, S.; Danquah, M. K.; Kusuma, V. A.; Freeman, B. D. Kalika, D. S., Relaxation properties of poly(ethylene oxide) copolymer networks: Influence of short-chain pendant groups. Abstracts of Papers of the American Chemical Society 2007, 234.
65. Lin, H.; Kai, T.; Freeman, B. D.; Kalakkunnath, S. Kalika, D. S., The Effect of Cross-Linking on Gas Permeability in Cross-Linked Poly(Ethylene Glycol Diacrylate). Macromolecules 2005, 38 (20), 8381-8393.
66. Ribeiro, C. P. Freeman, B. D., Carbon dioxide/ethane mixed-gas sorption and dilation in a cross-linked poly(ethylene oxide) copolymer. Polymer 2010, 51 (5), 1156-1168.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

What is claimed is:

1. A method for coating a porous support with a membrane selective layer, the method comprising:
immersing a porous support in a first solution such that the first solution is absorbed into the pores, the first solution containing a monomer,
removing the porous support from the first solution,
covering the porous support with a second solution immiscible with the first solution, the second solution containing a polymerization initiator,
activating the initiator to effect polymerization of the monomer, thereby forming a membrane selective layer on the porous support, and
washing the porous support having the membrane selective layer.

2. The method of claim 1, wherein the porous support is a hollow fiber or a sheet membrane.

3. The method of claim 2, wherein the porous support is a polysulfone membrane.

4. The method of claim 1, wherein the first solution is an aqueous phase and the second solution is an organic phase.

5. The method of claim 4, wherein the first solution further contains a porogen or a co-monomer.

6. The method of claim 5, wherein the monomer is polyethylene glycol diacrylate (PEGDA), poly(ethylene oxide) diacrylate, or poly(ethylene oxide) dimethacrylate.

7. The method of claim 5, wherein the porogen is PEG200 or PEG600.

8. The method of claim 5, wherein the co-monomer is amine-containing acrylate, zwitterionic acrylate, amine-containing methacrylate, zwitterionic methacrylate, or PEG monoacrylate.

9. The method of claim 8, wherein the co-monomer is polyethylene glycol methyl ether acrylate (PEGMEA), sulfobetaine methacrylate (SBMA), or (3-acrylamidopropyl) trimethylammonium chloride (APTMAC).

10. The method of claim 5, wherein the aqueous phase contains 5-20 v/v % PEGDA.

11. The method of claim 1, wherein the first solution is an organic phase and the second solution is an aqueous phase.

12. The method of claim 1, wherein the polymerization initiator is a photo-initiator, a thermal initiator, or a two-part redox initiator.

13. The method of claim 12, wherein the polymerization initiator is a photo-initiator.

14. The method of claim 1, wherein the membrane selective layer contains polyacrylate, polymethacrylate, or polyacrylamide.

15. The method of claim 1, wherein the first solution further contains a porogen or a co-monomer.

16. The method of claim 15, wherein the monomer is PEGDA, poly(ethylene oxide) diacrylate, or poly(ethylene oxide) dimethacrylate; the porogen is PEG200 or PEG600; and the co-monomer is PEGMEA, SBMA, or APTMAC.

17. The method of claim 1, wherein the polymerization initiator is activated under UV for a UV exposure time of 4-20 minutes.

18. The method of claim 17, wherein the polymerization initiator is activated for a UV exposure time of 5-10 minutes.

19. A membrane comprising a porous support coated with a membrane selective layer by the method of claim 1, wherein the selective layer is less than 200 nm in thickness.

20. The membrane of claim 19, wherein the selective layer is less than 100 nm in thickness.

21. The membrane of claim 19, wherein the porous support is a polysulfone membrane and the monomer is PEGDA.

22. The membrane of claim 19, wherein the membrane has an effective pore size less than that of the porous support.

23. The membrane of claim 19, wherein the membrane has a molecular weight cut off of 1000-100,000 daltons.
